(19) United States
(12) Patent Application Publication
(10) Pub. No.: US 2008/0195986 A1
(43) Pub. Date: Aug. 14, 2008

(54) POWER GRID TUNING FOR DC VOLTAGE EQUALIZATION

(75) Inventors: Erwin B. Cohen, South Burlington, VT (US); Mathew I. Ringler, Shelburne, VT (US)

Correspondence Address: SCULLY, SCOTT, MURPHY & PRESSER, P.C., 400 GARDEN CITY PLAZA, Suite 300, GARDEN CITY, NY, 11530, US

(73) Assignee: INTERNATIONAL BUSINESS MACHINES CORPORATION, Armonk, NY (US)

(21) Appl. No.: 11/674,325

(22) Filed: Feb. 13, 2007

(51) Int. Cl. G06F 17/50

(52) U.S. Cl. 716/5

(57) ABSTRACT

A method for tuning a plurality of supply voltages across and integrated circuit (IC) package that supplies a number of voltage supply regions within an IC chip. The inventive method includes extracting a power draw for each voltage supply region and the region's functional circuit blocks to generate a current map, assigning C4 bumps and module pins, and designing an IC package layout to define a supply grid of metal conductive power distribution wiring, analyzing the IC package layout using an IR-drop application, creating an internal plane voltage map and an internal plane current map for each of the IC package voltage supply planes and identifying required via and plane current changes necessary to tune the IC package in accordance with plane voltage and plane current maps, and repeating the steps of assigning, analyzing and creating until the IR drops within the voltage supply regions of the IC package are thoroughly balanced.

### BACKGROUND OF THE INVENTION

1. Field of the Invention

The present invention relates to integrated circuits (ICs). More particularly, the inventions disclosed and claimed herein relate to ICs and methods for tuning ICs to realize more uniform voltages across the IC.

2. Description of the Related Art

Power supply voltages are typically supplied to an integrated circuit (IC) from an external power supply source through interconnect or bond pads on the IC. The power supply voltages are routed from these pads to the transistors comprising the IC through metal conductors, referred to herein as “power distribution wiring,” that are formed on one or more layers for both horizontal and vertical power distribution. On the IC, the power distribution wiring is of varying lengths and widths, traversing the IC in a variety of patterns, including regular grids, irregular grids, serpentines and perforated wires. Power distribution wiring in the first level IC package consists of wires of a variety of widths, wires with a variety of diameters, and conductors patterned in plane shapes. As such, the path through the power distribution wiring supplying voltages and currents to any portion of the IC (e.g., transistors and functional circuit blocks) may differ physically in aggregate length, cross-sectional area and material composition from the power distribution wiring supplying voltages and currents to transistors and functional circuit blocks (e.g., macros) within other portions of the IC. Because power distribution wiring path resistances are determined by their respective lengths, cross-sectional areas, and material composition, the power distribution wiring paths to different portions of the IC have different resistance. Further, each section of the IC will require an amount of current that differs from the current requirements of other section. Thus the IR drop (Vdd-Vss) at the various positions of the IC may be decidedly non-uniform. That is, the magnitude of the voltage drop depends on the current demand, the lengths, cross-sections and the resistances of the conductive power distribution wiring.

For that matter, the speed of transistors and functional circuit block operation is partly dependent upon the magnitude of the power supply voltages they receive, whereby devices in locations of the IC that suffer large IR drops in their power distribution wiring maybe forced to operate at reduced speeds because of the reduced power supply voltage levels available to them. Other IC devices in locations that suffer less IR drop within their power distribution wiring will operate at relatively higher speeds. Of course this may result in timing problems such as increased clock skew or increased uncertainty propagation delay times through gates and flip-flops. In large ICs (e.g., VLSI), the non-uniformity in supply voltage is even more pronounced.

It would be welcomed in the art of IC chip design and IC chip package design to have available a technique or method for routing power supply voltages throughout an IC chip and IC package to reduce variations in power supply voltages received or provided to different voltage supply regions within the IC chip.

### SUMMARY OF THE INVENTION

To that end, the inventions described and set forth herein implement a method for tuning a grid of supply voltages provided to the semiconductor chip itself, and through the chip package in order to create uniform voltage levels across each voltage supply level within the IC chip. The inventive methods include identifying localized circuit current draws, and modifying the electrical/mechanical parameters of the IC package power supply conductors, the IC chip power supply conductors, or both. When implemented as set forth in detail herein, the inventive methods result in providing more spatially uniform voltage levels throughout the various voltage supply regions, e.g., within the IC chip, within and between localized functional blocks. Because the methods are preferably implemented in computer software, the invention includes a computer readable medium that includes a set of computer instructions which may be downloaded and executed by a general purpose computer in order to support IC chip and IC package design and fabrication.

### BRIEF DESCRIPTION OF THE DRAWINGS

The foregoing and other objects, aspects and advantages will be better understood from the following detailed description of embodiments of the inventions, with reference to the drawings, in which:

FIG. 1 is a logical block diagram depicting one embodiment of a method for tuning a power grid for an IC package in accordance with the invention;

FIG. 2 is a logical block diagram depicting one embodiment of a method for tuning a power grid for an IC chip in accordance with the invention; and

FIG. 3 is a logical block diagram depicting an embodiment of a method for tuning a power grid for both and IC chip and the IC package in accordance with the present invention.

### DETAILED DESCRIPTION OF THE INVENTION

The inventive methods, software and apparatus set forth herein are disclosed and described in order to convey the broad inventive concepts. The drawings and descriptions are not meant to in any way limit the scope and spirit of the inventions, as claimed.

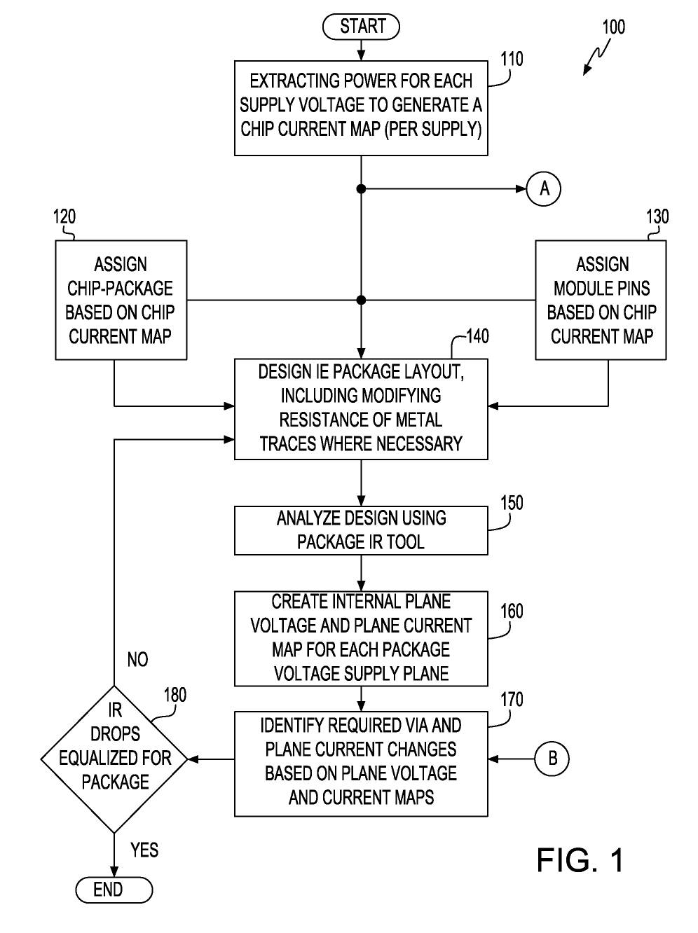

IC chips may have varied voltage needs, which may be supplied to various places within the chip's design through the IC package, as discussed above. For example, there may be a need for numerous voltage supplies required for IC chip operation such as 5 V, 0 V, −5V, 3.3 V, −3.3V, 2.0 V, −2.0 V, 2.5 V, −2.5 V, 1.2 V, −1.2 V, etc. Referring first to the logical block diagram of FIG. 1, a method for IR drop balancing or tuning (100) a power grid of an IC package in accordance with the invention will be described. When the inventive method is started or called, the power requirements for each of the chip's required supply voltages (for the voltage supply regions referred to herein) are derived or extracted, and a chip current map per supply is generated. Block 110 represents this step of generating the IC chip current map by extracting the power requirements for each of the voltage supply regions. Various applications are known for conducting such a process or step, including, for example, TexPower™.

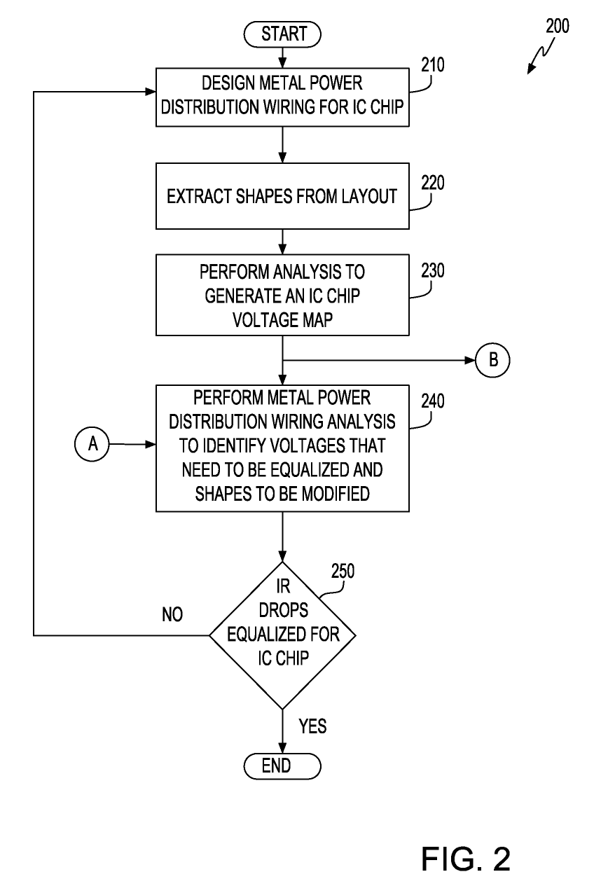

The chip current map may be used in the presently described process for the IC package depicted in FIG. 1, but is also used in the process for tuning the IC chip power grid, as depicted in the FIG. 2 process described in detail below. The designation A in FIG. 1 indicates that the chip current map is available for other uses such as IC chip IR balancing. Block 120 is representative of a step where the IC chip current map is used by the method to physically position and electrically assign the electrical contacts that connect the IC chip to the package. These contacts include “solder bumps”, “chip bumps”, “c4 pads” and wire bond pads. Block 130 is representative of a step where module pins are assigned for the IC package in accordance with the chip current map. Block 140 represents a step where the IC package design layout is generated. This step in the process may include modifying the power distribution routing extending from the pins through the IC package electrically connecting the various IC package voltage sources to the IC chip for normal operation. For example, the IC package design as initially available may require modification where it includes a legacy footprint of a pin layout for a prior IC design, including its peripheral array of wire bonds or bonding pads to which the IC chip will be mounted. That is, the routing of the conductive power distribution wiring of the legacy footprint must be modified to enable its use for the current design, as will be understood by the skilled artisan or IC designer.

Block 150 represents a step where the IC package design layout is analyzed using a package IR or voltage drop tool (i.e., I×R=V, or voltage drop). An example of a tool or application, which will analyze a package layout and design for IR drops, is HAL™, known to the skilled artisan. Block 160 represents a step in which an internal plane voltage map and plane current map are generated for each plane of the IC package. Known IC package designs may have multiple planes, for example, 10. Block 170 represents a step within which required vias, and various IC package plane current changes are generated in accordance with the voltage and current maps. That is, the resistances of the metal power distribution wiring are modified by varying their widths or lengths, adding extra power distribution wiring, removing or re-routing power distribution wiring, etc., to modify the IR drops to a voltage region. More, block 170 may include utilizing an IC chip voltage map. The IC chip voltage map may be generated in the IC chip IR balancing method, described in detail below with reference to FIG. 2, or may be available for use in this IC package R drop balancing method from other sources.

Decision step 180 represents where the method determines whether the various “R drops are equalized (balanced) across the package, and making any modifications to the conductive power distribution wiring in order to improve the balancing of the various 1R drops, where necessary. The modifications are implemented by changing conductive trace lengths, widths and routing, where necessary. The balancing is an iterative process, which if the IR drops throughout the IC package are not yet effectively balanced, to balance the voltages conveyed thereby (i.e., NO), the process winds back to the step represented by block 140 of the figure and repeats. When the most efficient tuning or balancing is realized, or determined, the IC package IR balancing is complete and the method is stopped (END).

FIG. 2 is a logical block diagram depicting one embodiment of a method for IR drop balancing or ting (200) of a power grid within an IC chip in accordance with the invention. Block 210 represents a step of designing, or otherwise making available the metal conductive power distribution wiring layout for the IC chip. Block 220 represents a step of extracting shapes for the functional blocks inherent in the IC chip design layout. Block 230 represents a step of analyzing the metal power distribution wiring layout and functional derived shapes layout in order to generate an IC chip voltage map. Various applications and processes are known that may be used for carrying out such an analysis, for example, the ALSIN™. As mentioned above, the voltage map created in step represented by block 230 may be utilized in the IC package IR drop balancing or tuning method described above with respect to FIG. 1, indicated by “B” in the figure.

Block 240 represents a step in which a metal power distribution wiring or conductive interconnect analysis is performed to identify voltages or IR drops within any of the supply voltage supply paths that need to be modified, or equalized, including shapes representative of supplied functional circuit blocks. The designation “A” represents that the IC chip current map generated in the FIG. 1 IC package IR balancing process may be supplied for use in the step of block 240 to support the analysis. Decision step 250 represents the portion of the method where it is determined whether all of the voltage supply regions and respective IR drops therein are equalized, where required. It is understood that the processing described with respect to blocks 210-250 are repeated until the respective IR drops are equalized. At this point the process is stopped (END).

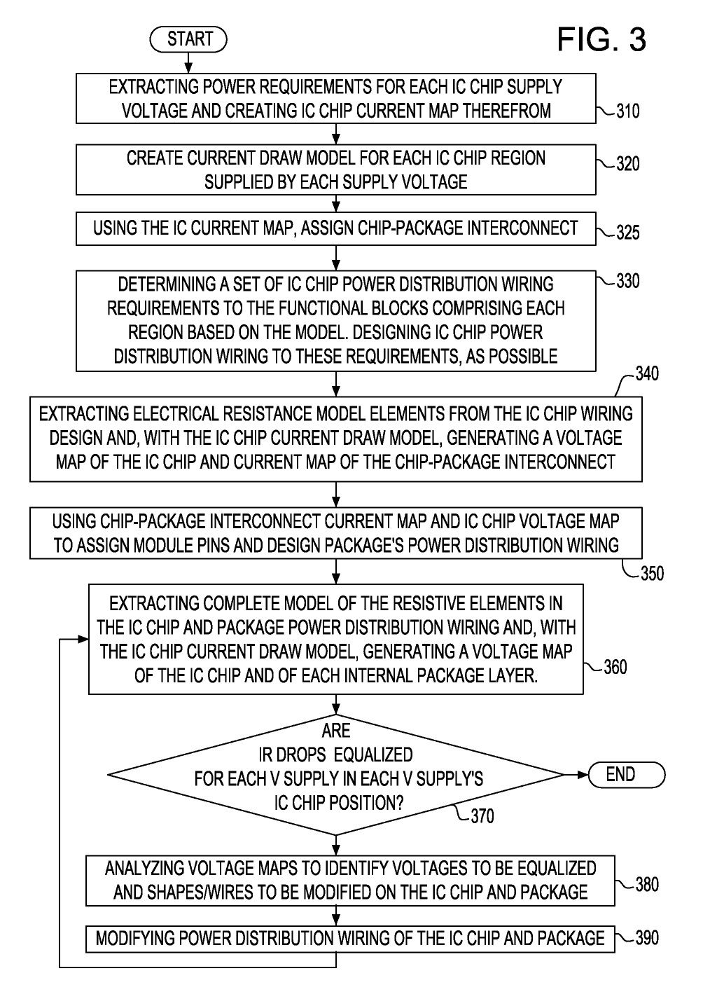

FIG. 3A is a logical block diagram depicting an embodiment of a method for tuning (IR drop balancing) a power grid for both an IC chip and the IC chip's package design (300) in accordance with the present invention. Block 310 is representative of a step within which an application or tool extracts the power requirements for each of the supply rails or voltages which are to be included in the IC chip design and creates a current map based on this data. Block 320 represents a step wherein a current draw model is generated for each voltage supply that includes each functional block or region supplied by the power supply voltage. The power supply model includes the currents draws for each functional block supplied by each respective voltage supply.

Block 325 represents as step where the positions and voltage rails of each chip-package interconnect site is assigned, as determined by the requirements of the IC chip current map. This includes assigning interconnect bumps and/or assigning peripheral array of conductive bond pads. The assigning should correlate to the IC chip voltage map requirements, which is particularly important when the IC module pin layout is a legacy footprint. Block 330 represents a step wherein an IC chip power grid is defined. This includes determining a set of power distribution wiring requirements for each of the supply voltages, and each of the functional blocks that each supply voltage supports in the IC chip, in accordance with the model.

Block 340 represents a step of analyzing the IC chip's metal power distribution wiring layout and functional derived shapes layout in order to incorporate their electrical resistances into a model and, with the chip current models, generating a map of IC chip voltages and IC chip-package interconnect voltages and currents.

Block 350 represents a step wherein the IC package layout is defined, including using the IC chip and interconnect voltage maps. The step includes assigning module pins and defining and the metal routing through the IC package. Block 360 represents a step of extracting and modeling the entire IC package design and IC chip design using an IR analysis tool (any known analysis TR tool). Included in this step, an internal plane voltage map and an internal plane current map are generated for each IC package supply plane, as well as a voltage map or the IC chip.

A decision step is performed, represented by diamond 370, to determine whether various IC chip voltages have been equalized or tuned. If not, the method proceeds to block 380, and the method continues iteratively until the IC chip voltages are effectively balanced (END).

Block 380 represents an analysis of the IC chip voltage map and the IC package plane voltage maps whereby the voltages to be equalized are identified. Further, package and IC chip power distribution wires that must be modified are identified to the end of balancing the voltages at the IC chip.

Block 390 represents a step wherein required via changes, and required plane current or voltage changes are implemented by modifying the IC chip and IC package conductive power distribution wiring lengths and/or thicknesses, and/or trace paths, in each supply plane based on the IC package plane voltage and plane current maps, as well as the IC chip voltage map. Following block 390, the method returns to block 360, and the method continues iteratively until the IR drops throughout the IC package are effectively balanced

Although a few examples of the present invention have been shown and described, it would be appreciated by those skilled in the art that changes might be made in these embodiments without departing from the principles and spirit of the invention, the scope of which is defined in the claims and their equivalents.

What is claimed is:

1. A method for uniformly maintaining a plurality of voltages supplying a plurality of respective voltage supply regions within an integrated circuit (IC) chip, the method comprising the steps of:
mapping a power draw of each voltage supply region, including each region's functional circuit blocks, to create a current map therefrom;
creating a power supply model for each voltage supply region including a current draw source representative of the region's respective functional circuit blocks, and creating a IC chip current map therefrom;
defining an IC chip power grid comprising conductive power distribution wiring requirements for each voltage supply region and the region's respective functional circuit blocks based on the power supply model; and
tuning the IC chip power grid, where necessary, by modifying the power distribution wiring requirements for each voltage supply region to render more uniform the IR voltage drops across and within each region's functional circuit blocks in accordance with the IC chip voltage and current maps.

2. The method for uniformly maintaining as set forth in claim 1, wherein the step of tuning the IC chip power grid includes defining a power draw rule for each functional block of each voltage supply region.

3. The method for uniformly maintaining as set forth in claim 1, wherein the step of tuning the IC chip power grid includes modifying one of a length and width of the conductive power distribution wiring within each of the voltage supply regions.

4. The method for uniformly maintaining as set forth in claim 1, wherein the step of tuning the IC chip power grid includes one of increasing or decreasing a resistance of the conductive power distribution wiring within each of the voltage supply regions.

5. The method for uniformly maintaining as set forth in claim 4, wherein the step of tuning the IC chip power grid includes modifying a number of the conductive power distribution wiring supplying the voltage supply regions.

6. The method as set forth in claim 1, further comprising a step of extracting shapes corresponding to the functional circuit blocks comprising each voltage supply region.

7. The method for uniformly maintaining as set forth in claim 1, further comprising a step of tuning an IC package into which the IC chip will be disposed.

8. The method for uniformly maintaining as set forth in claim 7, further including a step of mapping a power draw of the IC package to create a power draw map.

9. The method for uniformly maintaining as set forth in claim 8, further including a step of creating an IC package power draw model for a power grid comprising metal conductors that electrically connect and distribute the supply voltages through the IC package to the IC chip voltage supply regions and respective IC chip functional circuit blocks based on power draw map.

10. The method for uniformly maintaining as set forth in claim 9, further comprising a step of tuning the IC package power grid, where necessary, based on the package power model and power draw map, including equalizing voltage drops across the power grid.

11. The method for uniformly maintaining as set forth in claim 10, wherein the step of tuning the IC package power grid includes accommodating a legacy IC package footprint where there is an inconsistency between the legacy footprint for the IC package and a layout of the IC chip voltage regions and respective functional circuit blocks therein.

12. The method for uniformly maintaining as set forth in claim 11, wherein the step of tuning the IC package power distribution wiring includes one of increasing or decreasing a resistance of the IC package conductive power distribution wiring to equalize voltage drops throughout package power grid.

13. The method for uniformly maintaining as set forth in claim 12, wherein the step of tuning the IC package power distribution wiring includes assigning C4 designations for the IC package based on the model of the IC power draw mapping and the IC package power draw mapping.

14. The method for uniformly maintaining as set forth in claim 12, wherein the step of tuning the IC package power distribution wiring includes assigning IC package module pins based on the model of the IC power draw mapping and the IC package power draw mapping.

15. The method for uniformly maintaining as set forth in claim 8, wherein the step of tuning the IC package power distribution wiring includes creating an internal plane voltage map and internal plane current map for each plane of the IC package power grid.

16. A computer readable medium comprising a set of computer readable instructions, whereupon downloading and executing the set of instructions by a computer processor implements steps comprising the method set forth in claim 1.

17. The computer readable medium as set forth in claim 16, wherein the set of executed instructions includes implementing the step of tuning an IC package into which the IC chip will be disposed.

18. A method for tuning a plurality of supply voltages across and integrated circuit (IC) package that supplies a plurality of voltage supply regions within an IC chip, the method comprising the steps of:
extracting a power draw for each voltage supply region within an IC chip to be operated with the IC package, including each region's functional circuit blocks to generate a current map;
assigning C4 bumps and module pins, and designing an IC package layout including defining a package supply grid representative of the metal conductive power distribution wiring of the IC package layout;
analyzing the IC package layout using an IR-drop application;
creating an internal plane voltage map and an internal plane current map for each of the IC package voltage supply planes;
identifying required via and plane conductive trace changes necessary to tune the IC package in accordance with plane voltage and plane current maps, and repeating the steps of assigning, analyzing and creating until the IR drops within the voltage supply regions of the IC package are thoroughly balanced.

19. The method for tuning as set forth in claim 18, wherein the step of identifying further comprises generating an IC chip voltage map for a plurality of IC voltage supply regions and respective region functional circuit blocks to be supplied by the IC package, the wherein IC package supply regions correspond to the IC package regions.

20. The method for tuning as set forth in claim 19, further comprising steps of designing a conductive trace layout for each voltage supply region within the IC chip, extracting shapes for each functional circuit block comprising each voltage supply region in the IC chip, analyzing the layout to generate an IC chip voltage map, using the voltage map to perform an IC chip conductive trace analysis to identify voltages in voltage supply regions that require equalization, and modifying the lengths and widths of the metal power distribution wiring, where necessary, to equalize the voltage drops across the voltage supply regions.
